(19) United States
(12) Patent Application Publication
(10) Pub. No.: US 2005/0131834 A1
(43) Pub. Date: Jun. 16, 2005

(54) E-commerce by check

(75) Inventors: Herman Rodriguez, Austin, TX (US); Newton James Smith, Austin, TX (US); Clifford Jay Spinac, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/733,838

(22) Filed: Dec. 11, 2003

(51) Int. Cl. H04K 1/00; H04L 9/00; G06F 17/60

(52) U.S. Cl. 705/64

(57) ABSTRACT

Methods, systems, and media to facilitate payment by check for a web commerce transaction are contemplated. Embodiments include hardware and/or software for providing a purchaser with an encoded personal identification number (PIN); receiving the encoded PIN in response to an offer of payment by the purchaser to a merchant by check; decoding the encoded PIN; and comparing the decoded PIN with information associated with the purchaser to authenticate the purchaser and to verify that sufficient funds are available to the purchaser for the transaction. Many embodiments include encryption systems to encode a PIN or password to generate the encoded PIN. Further embodiments encourage Web Commerce merchants to accept personal, electronic checks on a regular basis for e-commerce transactions by providing a method for clearing checks immediately or practically as fast as clearing credit card payments.

### CROSS-REFERENCES TO RELATED APPLICATIONS

This application is related to U.S. patent application Ser. No. ______ entitled “E-CHECK AND E-COMMERCE”, attorney docket number AUS920030906US1, filed on the same day, the disclosure of which is incorporated herein in its entirety for all purposes.

This application is related to U.S. patent application Ser. No. ______ entitled “E-COMMERCE TRANSACTION AGGREGATION AND PROCESSING”, attorney docket number AUS920030904US1, filed on the same day, the disclosure of which is incorporated herein in its entirety for all purposes.

### FIELD OF INVENTION

The present invention is in the field of e-commerce. More particularly, the present invention relates to methods, systems, and media to facilitate payment via check for electronic transactions, such as Web commerce transactions over the Internet.

### BACKGROUND

Current web business processes for Point of Sale (POS) and checkout systems tend to prefer or to only accept payment for merchandise by credit card since payments via credit card can be cleared immediately and prior to providing the purchaser with the merchandise. For example, a customer may purchase a product with a credit card from a merchant electronically via the merchant's web site. The merchant will process the credit card payment, electronically communicating with the credit card company to verify that the credit card company is willing to pay the amount of currency described by the merchant for the transaction. Once the transaction is authorized, an approval code is provided to the merchant and the merchant completes the transaction by providing the customer with a receipt that includes the product and some description to identify the form of payment like the credit card utilized for payment.

Unlike credit cards, however, transactions that involve payment by check involve delays in processing, collectively referred to as a ‘float’ period, which prevent the merchant from immediately determining whether the bank associated with the check agrees to fund the transaction. More specifically, processing a check currently takes about 36-72 hours from the time a check is written until the check is actually paid out of the purchaser's account. One of the reasons for the delay is that the paper checks must be sent to a check clearinghouse like the Federal Reserve Bank/Clearinghouse where the amount of the check is manually entered and printed on the bottom right edge of the check. Then, the check is sent to the purchaser's bank where the check is sorted, scanned, and recorded for the monthly statement. After the purchaser's bank processes the check, the funds are deducted from the purchaser's account and transferred to the merchant's account. Thus, during the 36-72 hour ‘float’ period, the merchant can either send the merchandise or perform the service requested by the purchaser, e.g., risking the payment for the goods, services, cash, etc.

The merchant's bank is also disadvantaged because the merchant's bank will show the balance of the check in the merchant's bank account for the ‘float’ period. In particular, after the merchant receives the check and the merchant transmits the check to the merchant's bank. The merchant's bank, having received a negotiable instrument in the amount indicated on the check, credits the merchant's account by the amount on the check. However, the merchant will not know during the delay period of 36-72 hours, whether the check will actually clear, i.e., whether the purchaser actually has sufficient funds available for the transaction. A solution for the merchant's bank is to place a hold on the funds until the funds are actually received or for some standard number of days to make sure that the funds are transferred before the merchant can use the funds, effectively discouraging the merchant from accepting checks over credit cards.

One solution to this dilemma, currently the prominent solution, is to refuse to accept payment by check or to restrict payment for e-commerce transactions to credit cards or payment services, such as PayPal™. Thus, the purchaser, using a credit card, will receive the merchandise more quickly, tending to satisfy the purchaser at least from the stand point of convenience, and the merchant doesn't realize additional risks by shipping merchandise before a check clears.

At the same time, many purchasers are more reluctant to give out their credit card numbers to merchants for web commerce, or e-commerce, transactions over, e.g., the Internet, One reason for reluctance by purchasers to use their credit card for e-commerce transactions via the Internet, is that credit card companies tend to allow purchasers to spend to their credit limit, which is typically inflated to encourage spending. Such purchaser's prefer to pay by check, since they feel that payment by check provides them with more control over their funds.

### SUMMARY OF THE INVENTION

The problems identified above are in large part addressed by methods, systems, and media to facilitate payment via check for electronic transactions, such as Web commerce transactions over the Internet. One embodiment provides a method for e-commerce with a check. The method generally includes providing a purchaser with an encoded personal identification number (PIN); receiving the encoded PIN in response to an offer of payment by the purchaser to a merchant by check; decoding the encoded PIN; and comparing the decoded PIN with information associated with the purchaser to authenticate the purchaser and to verify that sufficient funds are available to the purchaser for the transaction.

Another embodiment provides an apparatus for e-commerce with a check. The apparatus contemplates a PIN module to provide a purchaser with an encoded personal identification number (PIN); a purchaser database to maintain information associated with the purchaser and an account associated with the purchaser; and a PIN processor to receive the encoded PIN in response to an offer of payment by the purchaser to a merchant by check, decode the encoded PIN, and compare the decoded PIN with the information associated with the purchaser to authenticate the purchaser and to verify that sufficient funds are available to the purchaser for the transaction.

A further embodiment provides a machine-accessible medium containing instructions, which when executed by a machine, cause said machine to perform operations. The operations can involve providing a purchaser with an encoded personal identification number (PIN); receiving the encoded PIN in response to an offer of payment by the purchaser to a merchant by check; decoding the encoded PIN; and comparing the decoded PIN with information associated with the purchaser to authenticate the purchaser and to verify that sufficient funds are available to the purchaser for the transaction.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system including a purchaser, a purchaser's bank, and a merchant coupled via a LAN and/or WAN to facilitate payment by check for a web commerce transaction;

FIG. 2 depicts an embodiment of a PIN module and a PIN processor to facilitate payment by check for a web commerce transaction;

FIG. 3 depicts an example of a flow chart to facilitate payment by check for a web commerce transaction; and

FIG. 4 depicts an example of a payment page having a payment by e-check option.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media to facilitate payment by check for a web commerce transaction are contemplated. Embodiments include hardware and/or software for providing a purchaser with an encoded personal identification number (PIN); receiving the encoded PIN in response to an offer of payment by the purchaser to a merchant by check; decoding the encoded PIN; and comparing the decoded PIN with information associated with the purchaser to authenticate the purchaser and to verify that sufficient funds are available to the purchaser for the transaction. Many embodiments include encryption systems to encode a PIN or password to generate the encoded PIN. Further embodiments encourage Web Commerce merchants to accept personal, electronic checks on a regular basis for e-commerce transactions by providing a method for clearing checks immediately or practically as fast as clearing credit card payments. In other words, it is very important for the merchant to know that there is money available in the purchaser's account to fund the transaction as indicated by the check, and that the funds will be transferred to the merchant in a timely manner, ideally in real-time.

When a Web customer makes a purchase from an e-commerce Web site, the customer, or purchaser, provides the check information such as the routing number for the bank, account number, and check number on a Web checkout form. In addition, the purchaser provides an encoded, personal identification number (PIN) such as a password to validate that the purchaser is the owner of the checking account and has authority to write the check. The merchant then requests validation or clearance of the check and transference of the funds from the purchaser's account to the merchant's account.

To protect the purchaser and encourage the purchaser to use checks for payment of e-commerce transactions, the PIN is not processed by the merchant, but instead it is encrypted prior to being sent to the merchant or is sent directly to the customer's bank rather than to the merchant. The encryption of the security PIN can be made by a shopping cart plug-in or other similar software. When the purchaser submits a check, the merchant in turn, submits that encrypted security PIN to the purchaser's bank for authorization along with the rest of the checking account information. When the purchaser's bank clears the check and the funds are transferred to the merchant's account, an acknowledgement is sent to the merchant from the merchant's bank to authorize the transaction.

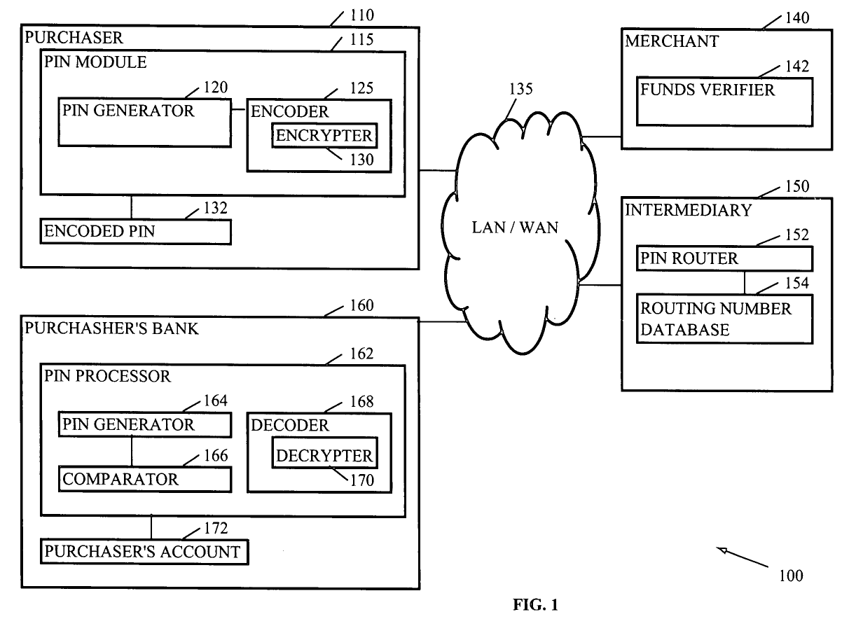

Turning now to the drawings, FIG. 1 depicts an embodiment of a system 100 to facilitate payment for a web commerce transaction by check. More specifically, system 100 may include a purchaser 110, a local area and/or wide area network (LAN/WAN) 135, a merchant 140, an intermediary 150, and a purchaser's bank 160. Purchaser 110 may include a customer operating any microprocessor-based device such as a laptop computer, a desktop computer, a personal digital assistant (PDA), a cellular phone, and the like, that have capabilities of executing a program such as pin module 115, or, in some embodiments, interacting with an application program interface (API) of purchaser's bank 160 to generate an encoded, personal identification number (PIN) 132 such as an encrypted password. For example, purchaser 110 may search for the best price for a printer via the Internet and find that merchant 140 offers payment by check as well as the best combination of price and shipping costs. Purchaser 110, given the opportunity by merchant 140 and preferring to purchase the printer by check, enters check information such as a routing number, an account number, and a check number for a check that purchaser 110 wants to use for the transaction.

In addition to supplying the routing number, account number, and check number, purchaser 110 generates encoded PIN 132 via PIN module 115 and uploads encoded PIN 132 to merchant 140, wherein merchant 140 transmits encoded PIN 132 along with the routing number, account number and check number and the amount to purchaser's bank 160 via intermediary 150. Purchaser's bank 160 approves the transaction for the amount based upon encoded PIN 132 being a valid PIN for purchaser's account 172 and sufficient funds being available to purchaser 110 in purchaser's account 172. Purchaser's bank 160 then transmits the approval to merchant 140.

Purchaser 110 may include PIN module 115 and encoded PIN 132. PIN module 115 may comprise client-side logic such as hardware and/or software to generate and encode a PIN for purchaser 110 to create encoded PIN 132. In some embodiments, PIN module 115, or part thereof, may be supplied to purchaser 110 by purchaser's bank 160 so encoded PIN 132 is predictable or partially predictable by PIN processor 162 of purchaser's bank 160. In particular, PIN module 115 may include a PIN generator 120 and an encoder 125. In some embodiments, PIN generator 120 may generate a code based upon facts such as the date and time, embedding an expiration into the code; the purchaser's name; a password known by or communicated to purchaser's bank 160 by purchaser 110; the routing number of purchaser's bank, etc. In several embodiments, the combination of facts selected to generate the code may be based upon the date and/or time of the generation of the code as a PIN so that the PIN can be generated by purchaser's bank 160 to verify the identity of purchaser 110. In other embodiments, the PIN may simply be a password known by both purchaser 110 and purchaser's bank 160. In further embodiments, a unique transaction number, like a check number, may be incorporated into the PIN to uniquely identify the transaction so encoded PIN 132 may not be used more than once to verify a transaction.

After the PIN is generated, encoder 125 may encode the PIN, including encrypting the PIN in the present embodiment, to create encoded PIN 132. Encoder 125 may, for instance replace repetitive portions of the PIN with common blocks or replace typical patterns of bits, such as ‘1011’, ‘1111’, ‘0011’, or other shorter or longer patterns of bits with a representation of the pattern. For example, a row of 4 consecutive zeros ‘0000’ may be replaced with a bit pattern like ‘110’ indicating a count of four as well as a zero.

Encoder 125 may also include an encrypter 130. Encrypter 130 may encrypt the PIN. In one embodiment, encrypter 130 may use a secret key, such as the Data Encryption Standard (DES) and Advanced Encryption Standard (AES) algorithms. With these algorithms, the sender, such as purchaser 110, and the receiver, like purchaser's bank 160, use the same key to encrypt and decrypt the PIN.

In a further embodiment, a public key cryptography is utilized. For instance, Rivest-Shamir-Adleman (RSA), a highly secure cryptography method by RSA Security, Inc., uses both a private and a public key. More specifically, the receiver, purchaser's bank 160, maintains the private key and the sender, purchaser 110, utilizes a public key for that purchaser's bank 160 to encrypt the PIN. Purchaser's bank 160 can then use the private key to decrypt encoded PIN 132 to obtain the PIN.

In some embodiments, both cryptographic methods may be used together, such as the DES secret key and the RSA public key algorithms. The secret key method provides the fastest decryption, and the public key method provides a convenient way to transmit the secret key, often referred to as a “digital envelope”.

In other embodiments, PIN module 115 may reside on a remote server from purchaser 110 such as purchaser's bank 160 and purchaser 110 may access PIN module 115 via LAN/WAN 135.

LAN/WAN 135 is a network connection to couple purchaser 110 with servers such that merchant 140, intermediary 150, and/or purchaser's bank 160 can transmit encoded PIN 132 between the computers. In some embodiments, LAN/WAN 135 may include a network in an office coupled via Ethernet, optical media like OptiConnect, or the like. In several embodiments, LAN/WAN 135 also couples with the Internet via a cable modem, a digital subscriber line (DSL), a T1 line, a T3 line, or the like. In further embodiments, LAN/WAN 135 may include a network of temporary connections such as connections via a telephone system.

Merchant 140 may include a merchant's Internet storefront, or web site, on a server or other type of computer. Merchant 140 may include funds verifier 142 to determine whether the payment from purchaser 110 clears and the funds are transferred to the merchant's bank account. More specifically, upon receipt of the routing number from purchaser 110, merchant 140 may facilitate transmittal of encoded PIN 132 from purchaser 110 to purchaser's bank 160 along with a request to clear a check from merchant 140 for an amount disclosed. After purchaser's bank decodes and verifies that the PIN from encoded PIN 132 is valid for purchaser 110 and purchaser's account 172, purchaser's bank 160 may transmit an indication that the check is cleared or that funds will be transferred to the merchant's bank. In other embodiments, purchaser's bank 160, upon verifying the transaction, immediately begins to transfer the funds in the amount indicated by the merchant and/or encoded PIN 132 to the merchant's bank. In further embodiments, encoded PIN 132 is transmitted directly to purchaser's bank 160 rather than being routed via merchant 140 and/or intermediary 150.

In some embodiments, the merchant's bank transmits the transaction or checking information, such as the routing number, account number of purchaser's account 172, check number, amount of currency represented by the check, and encoded PIN 132 to purchaser's bank 160 via an intermediary 150. Intermediary 150 may be, e.g., a check clearinghouse or the merchant's bank and may include PIN router 152 and routing number database 154 to identify an electronic address for purchaser's bank 160 based upon the routing number supplied by purchaser 110. For example, upon receipt of check information from purchaser 110, merchant 140 may transmit encoded PIN 132, the routing number, the account number, the check number, and the amount of the check to intermediary 150. Pin router 152 then looks up an electronic address such as an IP address and possibly a port number for purchaser's bank 160 via routing number database 154. Upon determining the electronic address, intermediary 150 routes the transaction information to purchaser's bank 160 via LAN/WAN 135.

Purchaser's bank 160 may be a bank and a server for the bank coupled with LAN/WAN 135 to clear electronic check transactions and, possibly, to credit the bank account of merchant 140. Purchaser's bank 160 may include PIN processor 162 and purchaser's account 172. PIN processor 162 may be related to PIN module 115 in that PIN processor 162 can determine or predict encoding of the PIN to create encoded PIN 132. For example, upon receipt of a request to clear a check of purchaser 110 from merchant 140, PIN processor 162 may decrypt encoded PIN 132 and decode the PIN to determine the date and time of generation of the PIN. If the date and time indicate that encoded PIN 132 is more than two hours old, then PIN processor 162 may reject the transaction based upon expiration of encoded PIN 132.

On the other hand, if encoded PIN 132 has not expired, PIN processor 162 may compare information from the PIN with information associated with purchaser's account 172 to determine whether the PIN verifies the identity of purchaser 110. In some of these embodiments, for instance, a PIN generator 164 may generate a PIN based upon the date and time information included within encoded PIN 132 and generate a PIN in the same manner as the PIN generated by PIN module 115. Then, comparator 166 may compare the PIN generated by PIN generator 164 against the PIN generated by PIN generator 120. When the PINs match, purchaser 110 may be verified as the owner of purchaser's account 172 and authorized to electronically sign and submit the e-check. Otherwise, the transaction may be rejected.

PIN processor also includes decoder 168. Decoder 168 is designed to decode PINs encoded by encoder 125. In some embodiments, decoder 168 may be designed to decode PINs encoded by different account holders by utilizing information associated with the corresponding accounts to perform the decoding. For instance, decoder 168 may be adapted to decode encoded PIN 132 by supplying decoder 168 with information, or at least giving decoder 168 access to information related to purchaser's account 172.

Decoder 168 may include decrypter 170. Decrypter 170 may decrypt encoded PIN 132 to determine the PIN, or at least facilitate access to information represented by the PIN. For example, decrypter 170 may decrypt encoded PIN 132 first with a public key and then with a secret key. After being decrypted, encoded PIN 132 may include encoded checking information such as the routing number, account number, check number or a unique transaction number, as well as the date and time for creation of the PIN and the date and time associated with expiration of the PIN.

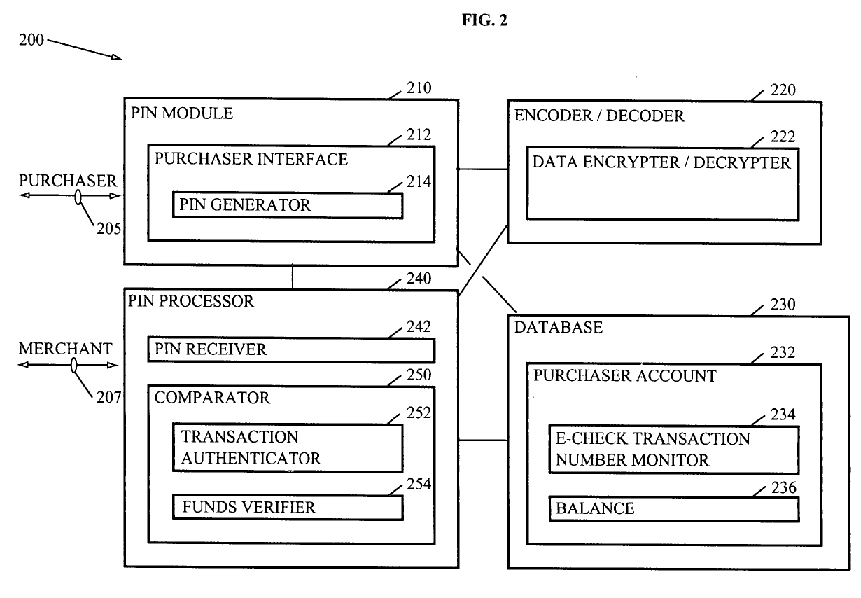

FIG. 2 depicts an embodiment of a device 200 including a PIN module and a PIN processor to facilitate payment by check for a web commerce transaction. Device 200 may be integrated with software on a server for a bank such as purchaser's bank 160 from FIG. 1. Device 200 includes hardware and software adapted to interact with a purchaser 205 to generate an encoded PIN and interact with a merchant 207 to clear an electronic check transaction with purchaser 205 via the encoded PIN. For example, purchaser 205 may interact with PIN module 210 to generate an encoded PIN and pass that encoded PIN to merchant 207 along with information to pay by check for a transaction with merchant 207. Then, PIN processor 240 may receive the encoded PIN from merchant 207 and verify that the transaction is trustworthy by authenticating the encoded PIN.

In the present embodiment, device 200 may include PIN module 210, an encoder/decoder 220, a database 230, and a PIN processor 240. PIN module 210 may provide a purchaser 205 with an encoded PIN. For example, when purchaser 205 desires to pay for an e-commerce transaction via check, purchaser 205 may log into PIN module 210. Logging into PIN module 210 may initiate a purchaser interface 212 designed to interact with purchaser 205 and database 230 to generate the encoded PIN. More specifically, purchaser interface 212 may establish access to purchaser account 232 based upon the login information supplied by purchaser 205 and PIN generator 214 may utilize some or all of the information contained by purchaser account 232 to generate a PIN. In some embodiments, purchaser 205 may supply a password that is included in the encoded PIN.

Once the PIN is generated, encoder/decoder 220 may encode the PIN to prevent access to the information included in the PIN by others. In many embodiments, in fact, purchaser 205 may not have the ability to decode the PIN. Encoder/decoder 220 may include a data encrypter/decrypter 222. Data encrypter/decrypter 222 may both encrypt and decrypt PINs depending upon whether the PIN is received with PIN module 210 or PIN processor 240. For example, after generating a PIN, purchaser interface 212 may forward the PIN to encoder/decoder 220 to encrypt the PIN prior to transmitting the PIN to purchaser 205. Once encrypted, the PIN is transmitted to purchaser 205 so purchaser 205 can upload the encoded PIN to the merchant selected by purchaser 205.

After receiving the encoded PIN, merchant 207 transmits the encoded PIN to PIN processor 240. Advantageously, merchant 207 is unable to decode the encoded PIN so purchaser can feel comfortable about transmission of the checking account information to merchant 207. PIN processor 240 then processes the PIN to verify the trustworthiness of the transaction forwarded by merchant 207 and if PIN processor 240 determines that the transaction is trustworthy based upon verification of the encoded PIN, PIN processor 240 may clear the electronic check, allowing funds to transfer from purchaser account 232 if purchaser account 232 has sufficient funds and/or credit to cover the amount of the transaction.

Database 230 may maintain information associated with the purchaser and the purchaser's account. More specifically, database 230 may include purchaser account 232. Purchaser account 232 may be data describing the balance 236 in the purchaser's account and include an e-check transaction number monitor 234. E-check transaction number monitor 234 may track, e.g., check numbers associated with electronic check transactions to prevent clearance of two transactions with the same transaction number. For instance, merchant 207 may receive an encoded PIN along with electronic check information to pay for merchandise ordered by purchaser 205. Merchant 207 may transmit the encoded PIN to PIN processor 240 to clear the electronic check and, after a short period of time has elapsed without acknowledgement of receipt of the encoded PIN by PIN processor 240, transmit the encoded PIN again along with the electronic check information. PIN processor 240 may compare the electronic check number, a unique transaction number, with e-check transaction number monitor 234 to determine whether the electronic check number is valid and if the number was used before. If the electronic check number has not been used and is a valid number, the electronic check may be cleared. In some embodiments, valid electronic check numbers are numbers within, e.g., five consecutive check numbers from the last check number processed. Further, the check numbers may be consecutive only in the sense that they are generated in order by PIN generator 214 and not necessarily in an ascending or a descending alphanumeric order.

PIN processor 240 may receive the encoded PIN in response to an offer of payment by purchaser 205 to merchant 207 by check. Then, pin processor may decode the encoded PIN and compare the decoded PIN with the information associated with purchaser 205 to authenticate purchaser 205 and to verify that sufficient funds are available to purchaser 205 for the transaction. In particular, PIN processor 240 includes PIN receiver 242 and comparator 250. PIN receiver 242 may receive an encoded PIN from merchant 207 in conjunction with a request to clear an electronic check, or e-check transaction and interact with encoder/decoder 220 to decrypt and/or decode the encoded PIN.

After decoding the encoded PIN, comparator 250 may include transaction authenticator 252 to compare a password embedded in the decoded PIN against a password received from purchaser 205 for the transaction. Transaction authenticator 252 may be designed to verify the authenticity of the encoded PIN. Further, comparator 250 may include a funds verifier 254 that, after verifying the authenticity of the e-check transaction, compares the amount of the transaction to the balance 236 in purchaser account 232. When balance 236 is insufficient to cover the amount of the transaction, taking into consideration any overdraft credit that purchaser 205 may have, PIN processor 240 will reject the transaction. Similarly, if the transaction is not determined to be trustworthy as a result of a failure to verify some information related to the encoded PIN, or because the encoded PIN expired before being received by PIN processor 240, PIN processor 240 may reject the transaction.

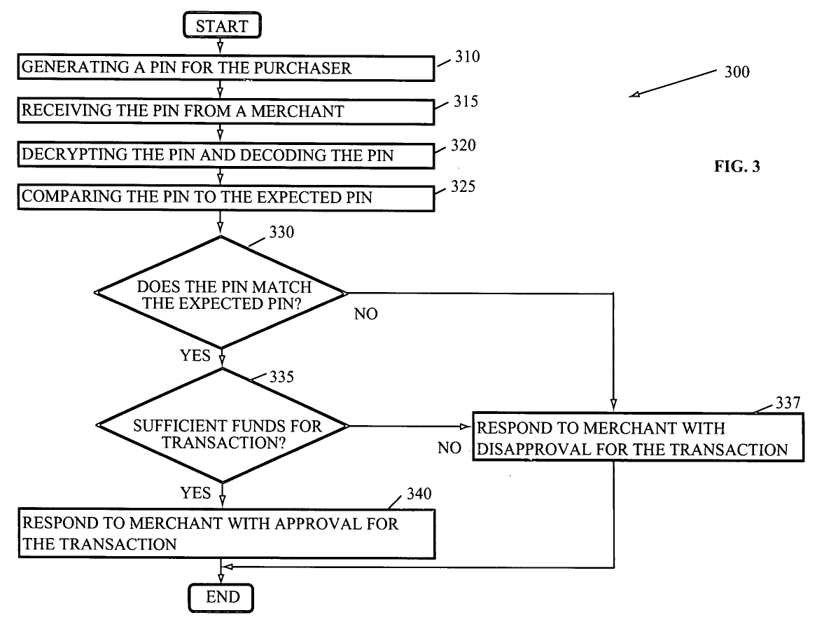

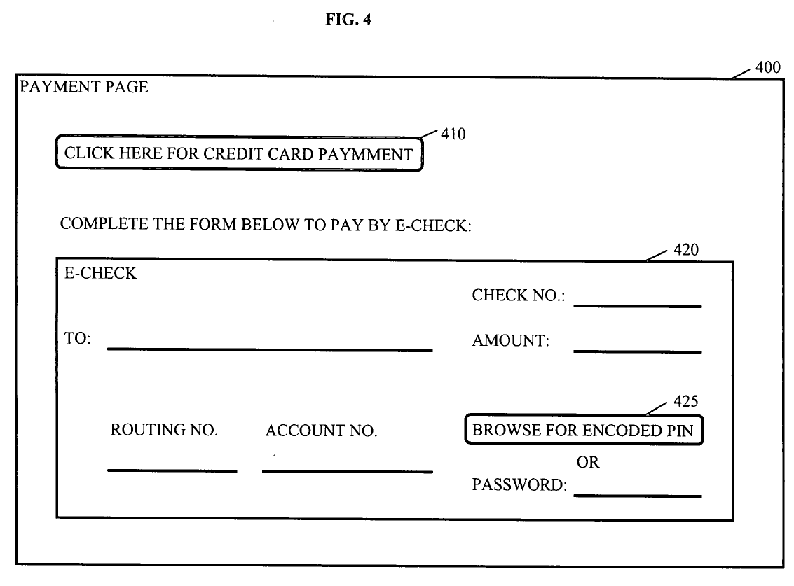

Referring now to FIG. 3, there is shown an example of a flow chart 300 to facilitate payment by check for a web commerce, or on-line transaction. Flow chart 300 begins with generating a PIN for the purchaser (element 310). For example, an e-commerce merchant system supports the routing of check clearing information to specific banks. The routing number is used to contact the customer's bank. Looking at FIG. 4, after a web-based customer selects items for his shopping basket and checks out on an e-commerce site, the e-commerce site may present a payment page 400 with a form that includes the option of paying for the purchase with a credit card 410 or an electronic check, such as e-check 420.

The customer, or purchaser, enters a bank routing number, optional check number, and account number on the form for an account having the purchaser as an authorized signatory. In addition, the purchaser enters a private e-check PIN. The PIN, or checking account password, is encrypted prior to submitting the e-check to the merchant. For instance, e-check 420 may include a browse to upload button like button 425 to allow the purchaser to identify the encrypted PIN, e.g., on the purchaser's local hard drive. The merchant then accepts the encrypted PIN, and transfers the encrypted PIN along with the check information to the purchaser's bank for payment, using the routing code submitted by the customer. In some embodiments, the form for e-check 420, or at least the password field, is provided through a trusted third party, the purchaser's bank, or another bank. The form can then encrypt the password or ensure that the merchant has no access to the password or PIN.

The purchaser's bank receives the encrypted PIN from the merchant (element 315) along with the check information and the purchaser's bank uses the customer's assigned PIN to authorize the submitted e-check request. More specifically, the encrypted PIN is decrypted and the encoded information in the PIN is decoded (element 320). The decoded PIN is then compared with the expected PIN (element 325), comparing, for example, information such as data associated with the purchaser's account or the purchaser.

When the PIN does not match the expected PIN (element 330) or the purchaser's account has insufficient funds to cover the transaction (element 335), a disapproval of the requested transaction is transmitted to the merchant in response to the transaction request (element 337). In some embodiments, when the PIN, password or other security information is invalid, the purchaser may be given a predetermined number of retries before the transaction is cancelled. Further, if the number of invalid PIN or password security retries is exceeded, the merchant may then reject the e-check transaction with the purchaser and the purchaser is notified by either the purchaser's bank or the merchant. Notification may be through e-mail, a Web page, or other suitable mechanism.

On the other hand, when the PIN does match the expected PIN (element 330) and the purchaser's account has sufficient funds to cover the transaction (element 335), the transaction is approved and the approval is transmitted to the merchant (element 340). In many embodiments, if the funds are available, they can be transferred immediately to the merchant's account and the merchant is notified to complete the transaction.

One embodiment of the invention is implemented as a program product for use with a computer system such as, for example, the system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., hard-disk drive or floppy disks within a diskette drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media to implement a personal identification number (PIN) to facilitate payment for electronic transactions via check. It is understood that the form of the invention shown and described in the detailed description and the drawings are to be taken merely as examples. It is intended that the following claims be interpreted broadly to embrace all the variations of the example embodiments disclosed.

1. A method for e-commerce with a check, the method comprising:
providing a purchaser with an encoded personal identification number (PIN);
receiving the encoded PIN in response to an offer of payment by the purchaser to a merchant with a check, by a bank associated with the check, wherein the bank is to decode the encoded PIN;
decoding the encoded PIN; and
comparing the decoded PIN with information associated with the purchaser to authenticate the purchaser and to verify that sufficient funds are available to the purchaser for the transaction.

2. The method of claim 1, wherein providing the purchaser with the encoded PIN comprises providing the purchaser with software to generate the encoded PIN, wherein generating the encoded PIN comprises encrypting a PIN.

3. The method of claim 1, wherein providing the purchaser with the encoded PIN comprises interacting with the purchaser to generate the encoded PIN prior to the transaction.

4. The method of claim 1, wherein receiving the encoded PIN comprises receiving the encoded PIN, forwarded by the merchant to the bank, in an encrypted form such that the merchant is a conduit through which the purchaser transmits to the encoded PIN to the bank.

5. The method of claim 1, wherein receiving the encoded PIN comprises receiving the transaction information with the encoded PIN, wherein the transaction information comprises a routing number, a bank account number, a check number, and an amount associated with the transaction.

6. The method of claim 1, wherein decoding the encoded PIN comprises decrypting the encoded PIN.

7. The method of claim 6, wherein decoding the encoded PIN further comprises decoding data embedded in the encoded PIN based upon a unique transaction number associated with the purchaser.

8. The method of claim 6, wherein decoding the encoded PIN further comprises decoding data embedded in the encoded PIN based upon an amount associated with the transaction.

9. The method of claim 6, wherein decoding the encoded PIN further comprises decoding data embedded in the encoded PIN based upon a date associated with the transaction.

10. The method of claim 1, wherein comparing the decoded PIN comprises comparing a password embedded in the decoded PIN against a password received from the purchaser for the transaction.

11. An apparatus for e-commerce with a check, the apparatus comprising:
a PIN module to provide a purchaser with an encoded personal identification number (PIN);
a purchaser database to maintain information associated with the purchaser and an account associated with the purchaser; and
a PIN processor to receive the encoded PIN in response to an offer of payment by the purchaser to a merchant with a check, decode the encoded PIN, and compare the decoded PIN with the information associated with the purchaser to authenticate the purchaser and to verify that sufficient funds are available to the purchaser for the transaction.

12. The apparatus of claim 11, wherein the PIN module comprises a client-side software application configured to generate the encoded PIN, the client-side software being configured to independently determine a unique transaction identification that authenticates the purchaser for the transaction to a bank associated with the account.

13. The apparatus of claim 11, wherein the PIN module comprises a software application configured to interact with a purchaser to encrypt a password to generate the encoded PIN.

14. The apparatus of claim 11, wherein the PIN processor is configured to receive the encoded PIN from the merchant, wherein the encoded PIN is designed to prevent the merchant from accessing identification information of the encoded PIN.

15. The apparatus of claim 11, wherein the PIN processor comprises a PIN decrypter to decrypt the encoded PIN.

16. The apparatus of claim 15, wherein the PIN processor further comprises a PIN decoder to decode the decrypted, encoded PIN.

17. The apparatus of claim 11, wherein the PIN processor comprises a comparator to compare the transaction amount with funds available to the purchaser for the transaction.

18. The apparatus of claim 17, wherein the comparator is configured to compare a password embedded in the decoded PIN against a password received from the purchaser for the transaction.

19. A machine-accessible medium containing instructions, which when executed by a machine, cause said machine to perform operations, comprising:
providing a purchaser with an encoded personal identification number (PIN);
receiving the encoded PIN in response to an offer of payment by the purchaser to a merchant with a check, by a bank associated with the check, wherein the bank is to decode the encoded PIN;
decoding the encoded PIN; and
comparing the decoded PIN with information associated with the purchaser to authenticate the purchaser and to verify that sufficient funds are available to the purchaser for the transaction.

20. The machine-accessible medium of claim 19, wherein providing the purchaser with the encoded PIN comprises providing the purchaser with software to generate the encoded PIN.

21. The machine-accessible medium of claim 19, wherein providing the purchaser with the encoded PIN comprises interacting with the purchaser to encrypt a PIN to generate the encoded PIN prior to the transaction.

22. The machine-accessible medium of claim 19, wherein decoding the encoded PIN comprises decrypting the encoded PIN.

23. The machine-accessible medium of claim 22, wherein decoding the encoded PIN further comprises decoding data embedded in the encoded PIN.

24. The machine-accessible medium of claim 19, wherein comparing the decoded PIN comprises comparing a password embedded in the decoded PIN against a password received from the purchaser for the transaction.
